(19) United States
(12) Patent Application Publication
(10) Pub. No.: US 2007/0110948 A1
(43) Pub. Date: May 17, 2007

(54) Multilayer, light-diffusing film for insert molding

(76) Inventors: Steven Lacock, Boyertown, PA (US); Jack Reilly, Blue Bell, PA (US); Manuel Garcia, Yardley, PA (US)

Correspondence Address: Thomas F. Roland, Esq.;Arkema Inc., 2000 Market St., Philadlephia, PA, 19103, US

(21) Appl. No.: 11/273,863

(22) Filed: Nov. 15, 2005

(51) Int. Cl. B32B 1/04

(52) U.S. Cl. 428/76

(57) ABSTRACT

A light-diffusing film includes a particle layer containing a polymer matrix having dispersed therein an effective amount of light-diffusing particles, and having a thickness in the range of 5 mil to 20 mil. The film may optionally also include a second polymeric layer adjacent and substantially coextensive with the particle layer, the second layer being translucent and having a thickness in the range of 5 mil to 50 mil. A third translucent layer may also be added. Molded articles having the inventive films on their surface, and methods of making them, are also disclosed.

### FIELD OF THE INVENTION

The invention relates to light-diffusing articles. More particularly, it relates to articles including a light-diffusing film.

### BACKGROUND OF THE INVENTION

There are numerous uses for lighted objects in a variety of industrial, commercial, and consumer applications. A few examples of such uses include tail light lenses for automotive vehicles, emergency exit signs for buildings, lighting fixtures, retail displays, and rear-lit projection screens. One particularly widespread application involves channel letters, which are illuminated from behind by a light source to produce lighted signs. Traditionally, the light source for channel letters has been a luminous tube such as a standard white fluorescent light, a neon light, or a mixed argon/mercury vapor lamp. However, there is increasing interest in the use of light emitting diode (LED) sources for channel letters as well as other applications, due perhaps in part to the high energy efficiency of these sources.

One problem that has been associated with the use of LED sources is that they are nearly point-source light emitters, and this is esthetically undesirable in some applications. In particular, LED light may show through standard channel letters and other lighting fixtures in a spotty and uneven manner. Thus, articles and methods for providing a more even light distribution through lighting fixtures are sought. In particular, methods for conveniently producing lighting fixtures having such properties, in any of a variety of shapes, would be a welcome advance in the sign-making art and other applications.

### SUMMARY OF THE INVENTION

In one aspect, the invention provides a film that includes:

a) a particle layer having a thickness in the range of 5 mil to 20 mil, the layer being translucent and including a polymer matrix having dispersed therein an effective amount of light-diffusing particles; and

b) a second layer adjacent and substantially coextensive with the particle layer, the second layer including a second polymer and being translucent and having a thickness in the range of 5 mil to 50 mil.

In another aspect, the invention provides an article including a translucent polymeric substrate having a surface thereof, and a film bonded to the surface. The film includes a translucent particle layer having a thickness in the range of 5 mil to 20 mil and including a polymer matrix having dispersed therein an effective amount of light-diffusing particles. The particle layer is adjacent and substantially coextensive with the surface of the substrate.

In yet another aspect, the invention provides a method of forming an article. The method includes:

a) placing in a mold a translucent film including a particle layer having a thickness in the range of 5 mil to 20 mil, the particle layer including a polymer matrix having dispersed therein an effective amount of light-diffusing particles; and

b) introducing into the mold a liquid polymer precursor or a melted thermoplastic polymer.

The liquid polymer precursor or melted thermoplastic polymer forms a translucent solid substrate bearing the film on a surface thereof.

### DETAILED DESCRIPTION OF THE INVENTION

The invention provides films containing at least a translucent light-diffusing particle layer, and optionally also including a second translucent (or even transparent) layer, as well as molded objects comprising such films on the surface of a substrate. A third translucent (or even transparent) layer may also be included to improve adhesion of the film to a substrate, as will be described in detail later. Methods of making such molded objects, as well as the films per se, are part of this invention. More specifically, the molded objects may be prepared by injection molding a polymer into a mold in which the inventive film has been pre-positioned, so that the film ultimately resides on a surface of the substrate formed by the injected polymer. Examples of molded objects than may be prepared using the articles and methods of this invention include tail light lenses for automotive vehicles, emergency exit signs for buildings, lighting fixtures, channel letters, retail displays, and rear-lit projection screens. One particularly useful embodiment may be the manufacture of illuminated signs, especially those illuminated internally by LED sources. The composition and preparation of the inventive films will now be described, followed by a description of molded parts and methods of making them.

Particle Layer

Films for use according to the invention include a particle layer that includes a thermoplastic polymer matrix having dispersed therein an effective amount of light-diffusing particles. The thickness of the particle layer is in the range of 5 mil to 20 mil, more commonly in the range of 7 mil to 15 mil. In some embodiments of the invention, the particle layer is used to scatter light from a point source (such as a light emitting diode, or LED) behind the film (or behind a molded object bearing the film on its surface), such that the approximately point source character of the LED is effectively hidden when it is viewed through the film or object. The particle layer is translucent, by which it is meant that it is capable of transmitting sufficient visible light that it may function as a covering, or a part of a covering, through which a viewer may see light from a light source. Unless otherwise specified, a translucent layer may be hazy, cloudy, or otherwise light-diffusing, or it may be so clear as to be transparent.

The thermoplastic matrix used in the particle layer has a refractive index differing by greater than 0.001 from the refractive index of the particles dispersed in it (to be described later herein). Suitable thermoplastics include polycarbonate (PC), glycol-modified polyethylene terephthalate (PETG), polyvinyl chloride (PVC), impact modified PVC, polyesters (PET, PBT, APET, etc.), styrene acrylonitrile (SAN), acrylonitrile-acrylate copolymer, acrylonitrile-methyl methacrylate copolymer, methyl methacrylate-styrene copolymer, methacrylate-butadiene-styrene terpolymer, acrylonitrile-styrene-acrylate (ASA) terpolymer, acrylonitrile butadiene styrene (ABS) terpolymer, polystyrene (PS), high impact polystyrene (HIPS), polyolefins, impact modified polyolefins, polycyclohexylethylene, cyclic olefin copolymer (COC), polyvinylidene fluoride (PVdF), PVdF-acrylic copolymers, imidized acrylic polymer, acrylic polymers, impact modified acrylic polymers, etc., or mixtures thereof. The term “acrylic polymer(s)” as used herein encompasses alkyl methacrylate homopolymers, copolymers of alkyl methacrylates with other alkyl methacrylates or alkyl acrylates or other ethylenically unsaturated monomers, alkyl acrylate homopolymers, and copolymers of alkyl acrylates with other alkyl acrylates or alkyl methacrylates or other ethylenically unsaturated monomers. The alkyl groups in these polymers may contain from 1-18 carbon atoms, typically 1-4 carbon atoms.

Typically the thermoplastic matrix material is acrylic and comprises a polymer or copolymer of methyl methacrylate (MMA); typical copolymers include 60-99% MMA and 1-40%, more typically 1-25%, of (C₁-C₁₀) alkyl acrylates, such as methyl acrylate (MA) and ethyl acrylate (EA). Unless otherwise specified, percentages in compositions described herein are by weight. Suitable commercially available poly (methyl methacrylate) type thermoplastic matrix materials include, as nonlimiting examples, PLEXIGLAS grades V(825), V(825) HID, V(826), V(046), V(045), V(052), V(920), VM, and VS. In some embodiments, the matrix polymer has a monomer content of 90-98% MMA and 2-10% EA, and for some applications the polymer is about 95-97% MMA and about 3-5% EA. Methods of preparing such polymers are well known in the art. For example, thermoplastic matrix materials may be prepared by a conventional bulk process (for example, a continuous flow stirred tank reactor (CFSTR process), solution, suspension or emulsion polymerization techniques, in which case conventional isolation processes used to recover the polymer in particulate form may include, for example, filtration, coagulation and spray drying.

The matrix may also comprise any of the acrylic polymers described above, modified by the addition of certain acrylic polymeric additives. These additives are described in detail in U.S. Pat. No. 6,852,405 to Wanat et al., the entire specification of which is expressly incorporated herein by reference. Typically, the composition of the acrylic polymeric additives may be 5-90% methyl methacrylate, 10-95% C₂-C₄ alkyl methacrylate, and optionally 0-5% acrylic monomers such as methacrylic acid, acrylic acid or C₁-C₅ esters thereof, and can be made by appropriate modifications of the same processes as may be used for making acrylic matrix polymers, as described above. In one embodiment the additive is an 80-20% MMA and 20-80% butyl methacrylate (BMA) copolymer having a molecular weight in a range from 40,000-300,000, preferably 40,000-100,000. In another embodiment, the additive is a 50-80% methyl methacrylate and 20-50% butyl methacrylate copolymer having a weight average molecular weight in a range from 25,000-300,000, preferably 25,000-100,000.

In one embodiment of the invention, the polymeric additive may be extrusion melt blended into ATOFINA Chemicals, Inc. Plexiglas V-grade or impact acrylic grade resin to give an optically clear matrix (before the addition of particles), having much higher adhesion to high impact polystyrene than do acrylics without the additive. In particular, the addition of 5 to 40, preferably around 5 to 30, most preferably about 10 to 25 weight percent of a MMA/BMA copolymer may provide noticeable improvement in adhesion of the particle layer to a HIPS substrate, without significant adverse effects on the beneficial physical properties of the acrylic layer. Adhesion to other substrates may also be improved by inclusion of acrylic polymeric additives, depending on the particular composition of the additive and that of the substrate.

The polymer matrix may be conveniently prepared by conventional cell casting or melt extrusion processes and is typically provided in particulate form. The matrix may also include other modifiers or additives such as are known in the art. For example, the composition may contain colorants, impact modifiers, external lubricants, antioxidants, flame retardants or the like. If desired, ultraviolet stabilizers, thermal stabilizers, flow aids, and anti-static agents may also be added. However, in some applications the inclusion of these or other additives may not be desirable, and in such cases the particle layer may be free of additives.

The particles that are dispersed in the polymer matrix to form the particle layer may be of any sort that provides a visible level of light scattering when light passes through the film, and are typically greater than 1 μm in size. Exemplary particles may be inorganic pigments such as titanium dioxide, iron oxide, alumina, aluminum hydroxide, aluminum, pigments, carbon black, silica, barium sulfate, and calcium carbonate. Other examples include organic polymers. In some embodiments, the polymeric particles comprise methyl methacrylate repeat units. In certain embodiments, the particles may comprise crosslinked polymers. Suitable examples include crosslinked polymethyl methacrylate, crosslinked polymethyl methacrylate modified with an acrylate or methacrylate monomer, crosslinked copolymers of methyl methacrylate and styrene, silicone resins and polyallyl methacrylates. As a general rule, the ability to scatter sufficient light will be provided by particles having a different refractive index than that of the polymeric matrix in which they are dispersed.

Preferred materials used to produce the particles, as well as preferred materials for making the matrix, have a refractive index of 1.46-1.59 when measured in conformance with ASTM D 542. However, in order to achieve the desired high haze or hiding power characteristics, the refractive indices of the particles and matrix in the films of the present invention must differ by greater than 0.001 units, and typically they will differ by greater than 0.002 units. In some embodiments, it is desired that the difference not be too great, and therefore in some cases the difference in refractive index between the particles and the matrix is less than 0.015, or even less than 0.010.

Specific examples of suitable crosslinked particles will now be described in detail. The crosslinked particles may be made of a polymer having an index of refraction ranging from 1.46 to 1.59. Exemplary crosslinked particles may be made by a suspension process, with one example type of crosslinked particles comprising 0-99.99% styrene, 0-99.99% alkyl methacrylate or alkyl acrylate, or a mixture of both, and 0.01-5% crosslinking agent. A typical composition may comprise 0-99.9% styrene, 0-99.9% methyl methacrylate, 0-20%, preferably 1-5%, of (C₁-C₁₀) alkyl acrylates such as methyl acrylate (MA) and ethyl acrylate (EA), and 0.1-2.5% crosslinking agent.

Crosslinking monomers suitable for use in making the polymer particles are well known to those skilled in the art, and are generally monomers bearing at least two vinyl groups capable of copolymerizing with other monomers in the reaction mixture. Depending on the specific situation, the crosslinker may be chosen such that the vinyl groups are the same, or different. Exemplary crosslinking monomers include divinyl benzene, glycol di- and tri-methacrylate and acrylates, allyl methacrylates, diallyl maleate, allyl acryloxypropionates, butylene glycol diacrylates, etc. Typical crosslinkers may include ethylene glycol dimethacrylate, divinyl benzene, and allyl methacrylate.

The particles, which preferably are spherical, have a mean particle size of about 4 to 100 μm, preferably 15-70 μm and most preferably 25-65 μm, and a particle size distribution wherein 95% of the particles are in a range of 1-110 μm. The foregoing numbers are on a weight basis. Spherical particles may be made by a suspension process using water as a continuous phase serving as a heat transfer medium, with polymerization being carried out in suspended monomer droplets. Particle size distribution is affected by agitation speed, monomer composition, and level of suspending agent, and methods of adjusting particle size are know to those of skill in the art. Such processes are described for example in U.S. Pat. No. 5,705,580, EP 0,683,182-A2, and EP 0,774,471-A1. Particle sizes may be measured by light scattering, according to ASTM D 4464.

The particles may be dispersed in the thermoplastic polymer matrix by any suitable method known in the art. One particularly appropriate method is as follows, in the case where the particles are crosslinked particles described above. The thermoplastic matrix resin is dried in a dehumidifying, forced hot air oven before being compounded with the crosslinked particles through, for example, a single-screw extruder equipped with a two-stage, medium work screw and a vacuum venting system. Alternatively, a twin screw extruder equipped with a vacuum venting system may be used for the compounding. The particles, the matrix resin, and (optionally) additives are added into the feed hopper of the extruder using separate feeders. The particles are metered into the feed hopper of the extruder by gravimetric control or by volumetric feeding control, using a feeder equipped with an auger screw. An exemplary temperature profile for making the particle layer resin when the composition contains 1-60% suspension particles and 40-99% thermoplastic, preferably acrylic made by a free radical polymerization process, is as follows (for a single screw, compounding extruder):

| | |
|---|---|
| Barrel Zone 1: | 225-240° C. |
| Barrel Zone 2: | 235-255° C. |
| Barrel Zone 3: | 245-260° C. |
| Screw Speed: | 60-100 RPM |
| | (revolutions per minute) |

The continuously-produced extrudate is cooled by running the strand through a water bath and subsequently cutting it into particle layer resin pellets. This resin is typically oven dried before being converted to the particle layer, as will be discussed below.
Second Layer

Films according to the invention may include a second polymeric layer adjacent and substantially coextensive with the particle layer. The second polymeric layer is translucent, and may be transparent, and has a thickness in the range of 5 mil to 50 mil. In most cases, the layer will be essentially free of colorants. Typically the thickness will be in the range of 7 mil to 30 mil, and more typically in the range from 7 mil to 15 mil. The combined thickness of the particle layer, the second layer, and the third layer (if present) will generally not exceed 50 mil, and typically will be at most 40 mil. To aid forming operations, some embodiments use even thinner films. Thus, in some cases, the combined thickness may be at most 30 mil, or at most 20 mil. The inventors have found that, by using suitably thin films, it is possible to perform molding operations in which the films conform to the mold and allow formation of an object bearing a light-diffusing layer on its surface, or a light diffusing layer just below a surface such that the molded object has a high level of gloss.

The optional second polymeric layer is bonded to the particle layer by any means known in the polymeric film art, such as laminating, compression molding, coextrusion, or solvent casting. The second layer may be made of any film-forming thermoplastic polymer known in the art, as long as it is capable of being bonded to the particle layer. For example, any polymer described above for use in the thermoplastic polymer matrix of the particle layer is suitable for use. Generally, the refractive index of the second layer will be within 0.2 units of that of the polymer matrix used in the particle layer.

The second layer may also include other modifiers or additives such as are known in the art. For example, the composition may contain colorants, impact modifiers, external lubricants, antioxidants, flame retardants or the like. If desired, ultraviolet stabilizers, thermal stabilizers, flow aids, and anti-static agents may also be added. However, in some applications the inclusion of these or other additives may not be desirable, and in such cases the second layer may be free of additives.

Third Layer

A third layer may be incorporated into the film structure, and it may lie on the particle layer or the second layer. The third layer, if present, may contain any of the acrylic polymer matrices, modified with an acrylic polymeric additive, discussed above with respect to the particle layer. The use of such a layer may, for the reasons already discussed, improve adhesion to certain substrates. Accordingly, if a third layer is present in a molded article made with the films of this invention, it will typically be on the side of the film that is in contact with the substrate, thereby improving adhesion. In such cases, it may not be necessary for the particle layer to comprise an acrylic polymeric additive, but the use of such additives in both the particle layer and the third layer is within the scope of this invention.

Making the Film

If the film consists only of the particle layer, it may be produced by any film-making process known in the art, such as extrusion or solvent casting. If the optional second and third layers are included, they may also be provided by any known means, for example extrusion to form separate film layers and then compression molding the layers together to form the film. Typically, especially in the case of two layers, the layers will be formed simultaneously in a co-extrusion process, as will now be described. The same general method, appropriately modified, may be used to form a three-layer film.

For cases where the particle layer and the second layer have the compositions discussed in detail above, a co-extruded product may conveniently be produced by a process using two or more extruders. Typically, there is a minimum of a primary extruder and a secondary extruder, but there may also be additional extruders, such as a tertiary extruder, etc. The primary extruder is usually the largest extruder and has the highest throughput rate compared to the other individual extruder(s). Therefore, for example, in a two-layer film configuration, the resin used to form the second layer is typically fed into the primary extruder and the particle layer resin is typically fed into the secondary extruder when using a co-extrusion set-up consisting of two extruders.

Each extruder separately melts the resin fed to it and the melt streams are then combined—typically in a feedblock system or in a multi-manifold die set-up. In the feedblock system, a plug is installed that determines how these two melted polymers will be layered in the final film. Hence, the polymer melt streams enter into the feedblock separately and are selectively combined within the feedblock. For a two-layer film configuration, the particle layer may be located on either the top or bottom side of the second layer. Once the polymer melt streams are selectively layered and co-mingled in the feedblock, the combined melt stream exits the feedblock and enters the die where the combined melt stream is spread to the width of the die. The melted polymer extrudate is then formed between highly polished chrome-plated, temperature-controlled rolls, which smooth and cool the film to the desired overall thickness.

Typical process conditions for two-layer film co-extrusion using a primary and secondary extruder and a feedblock/die assembly are listed below:

| | Conditions |
|---|---|
| Primary Extruder | |
| Barrel Zones: | 199-275° C. |
| Screw Speed: | 30-85 RPM |
| | (revolutions per minute) |
| Secondary Extruder | |
| Barrel Zones: | 221-280° C. |
| Screw Speed: | 5-50 RPM |
| | (revolutions per minute) |
| | Temperature |
| Feedblock | |
| Zones | 220-260° C. |
| Die | |
| Zones | 220-290° C. |
| Polishing Rolls | |
| All | 80-120° C. |

Alternatively, a multi-manifold die may also be used to achieve a layered film instead of a feedblock system. The polymer melt streams enter the multi-manifold die separately and are selectively combined and spread to the width of the die, all within the multi-manifold die.

Molded Articles

The invention also provides molded articles incorporating on a surface thereof a film as described herein above. The molded articles may be prepared by any means known in the art. In some embodiments, the method involves placing the film in a mold and then introducing a liquid polymer precursor or a melted thermoplastic polymer to form a substrate on which the film resides. The substrate is translucent, and may be transparent. Most commonly a melted thermoplastic polymer will be used to form the substrate, and suitable examples include any of the thermoplastic matrix polymers described above for use in the particle layer. In certain embodiments of the invention, the thermoplastic polymer comprises (meth)acrylic ester repeat units. As used herein, the terms “(meth)acrylic” and “(meth)acrylate” encompass both acrylic and methacrylic species. In some cases, a polymethyl methacrylate homopolymer will be used.

If a liquid polymer precursor is used instead, it may include any liquid composition that forms a solid polymer in the mold. Nonlimiting examples of such precursors include thermosetting compositions such as mixtures of epoxy resins and amine hardeners, unsaturated polyesters initiated with free radicals such as peroxides, and liquid acrylic molding resins. Typically, regardless of whether a melted thermoplastic polymer or a polymer precursor is used, the final polymer in the substrate will have a refractive index that is within 0.2 units of that of the polymer matrix used in the particle layer.

Formation of molded articles using the films of this invention may be accomplished by a film insert molding process. A typical sequence of steps in forming a molded article in this way includes cutting a film that includes a particle layer as described above to fit the mold, closing the mold to form a friction fit with the film, and back filling the mold with melted thermoplastic polymer, after which the article is cooled and removed from the mold. Placement of the film in the mold may be such that the optional second polymeric layer (when a second layer is used) is against an internal surface of the mold, so that the melted thermoplastic polymer or liquid polymer precursor contacts the particle layer (or the third layer, if present). Thus, the molded article bears the second polymeric layer on its surface, with the particle layer between that layer and the substrate. This will typically give a glossy or “wet” look to the article. In such cases, 60° gloss values (measured in air on the surface bearing the second polymer layer) will typically be at least 60, more typically at least 75. However, if the positioning of the film is reversed, or if a film employing only a particle layer is used, the molded item will bear the particle layer on its surface. This mode of operation may be used when a lower gloss or matte appearance is desired, for example to reduce glare or for aesthetic reasons. In the case of matte surfaces, an 850 gloss value is traditionally used, and values less than 12 can typically be achieved. More commonly, the gloss is less than 8.

Molded articles prepared according to the invention may be of any thickness. In some embodiments, the total thickness (including the film and the injected polymer) is in a range from 0.005″ to 0.5″, typically in a range from 0.020″ to 0.125″. The articles may be of nearly any shape and size. They may be essentially flat, or they may have curved internal and/or external surfaces. The preparation of essentially any shape that can be made by a molding process is contemplated according to the invention. Closed curved shapes such as cylinders, open curved shapes such as bowl-like or trough-like shapes, and others are all possible. The surfaces of the substrate underlying the film may be concave or convex. Nonlimiting examples of articles that may be made include tail light lenses for automotive vehicles, emergency exit signs for buildings, light diffusers, lighting fixtures, retail displays, and projection screens. One particularly useful embodiment may be the manufacture of tail light lenses for automotive vehicles, especially those illuminated internally by LED sources. Thus, in some embodiments of the invention, the article further comprises a light source fixed in proximity to the surface such that light from the light source passes through the film. The light source may be of any sort, with examples being incandescent bulbs, fluorescent bulbs, luminous tubes such as neon bulbs, and light emitting diodes. The light source may be placed such that light enters the molded object through the surface that bears the film, or it may be placed on the opposite side of the object. The light source may be placed in contact with the molded article, but typically it will be placed at some distance from it. Usually, the distance will be greater than one inch, and more typically it will be greater than two inches. The distance will usually be no greater than twelve inches, and more commonly no more than six inches.

### EXAMPLES

Gloss values (60°) were measured in air on the surface of plaques prepared by insert molding polymethyl methacrylate in a mold in which a two-layer film of this invention had been pre-positioned with the second layer facing outward. Thus the second layer was outermost on the finished plaque. Gloss was measured according to ASTM D523, modified so that five readings were taken on a 2″×3″ plaque and an average calculated from the five. The average gloss measured according to ASTM D 523 was 82.5 with a standard deviation of 2.6. The gloss measured on the substrate itself was 88.1, with a standard deviation of 0.9.

Another set of plaques was prepared, this time with the particle layer facing outward. The average 60° gloss measured on the film was 5.5 with a standard deviation of 0.1. The gloss measured on the substrate itself was 83.1, with a standard deviation of 0.9. Gloss numbers taken on the film at 85° had an average value of 6.5, with a standard deviation of 0.2.

Although the invention is illustrated and described herein with reference to specific embodiments, it is not intended that the subjoined claims be limited to the details shown. Rather, it is expected that various modifications may be made in these details by those skilled in the art, which modifications may still be within the spirit and scope of the claimed subject matter and it is intended that these claims be construed accordingly.

What is claimed is:

1. A film comprising
a) a particle layer having a thickness in the range of 5 mil to 20 mil, the layer being translucent and comprising a polymer matrix having dispersed therein an effective amount of light-diffusing particles; and
b) a second layer adjacent and substantially coextensive with the particle layer, said second layer comprising a second polymer and being translucent and having a thickness in the range of 5 mil to 50 mil.

2. The film of claim 1, wherein the polymer matrix comprises a (meth)acrylic ester polymer or copolymer.

3. The film of claim 1, wherein the thickness of the particle layer is in the range of 7 mil to 15 mil.

4. The film of claim 1, wherein the particles comprise crosslinked polymeric particles comprising methyl methacrylate repeat units.

5. The film of claim 1, wherein the film is a coextruded film.

6. The film of claim 1, wherein the second polymer comprises a (meth)acrylic ester polymer or copolymer.

7. The film of claim 1, further comprising a third layer adjacent and substantially coextensive with the particle layer or the second layer, the third layer comprising a copolymer consisting of 80-20% methyl methacrylate and correspondingly 20-80% butyl methacrylate repeat units and having a molecular weight in a range from 40,000-300,000, or a copolymer consisting of 50-80% methyl methacrylate and correspondingly 20-50% butyl methacrylate repeat units and having a weight average molecular weight in a range from 25,000-300,000.

8. An article comprising a translucent polymeric substrate having a surface thereof, and a film bonded to the surface, the film comprising a translucent particle layer having a thickness in the range of 5 mil to 20 mil and comprising a polymer matrix having dispersed therein an effective amount of light-diffusing particles;
wherein the particle layer is adjacent and substantially coextensive with the surface of the substrate.

9. The article of claim 8, wherein the polymer matrix comprises a (meth)acrylic ester polymer or copolymer.

10. The article of claim 8, wherein the particles comprise crosslinked polymeric particles comprising methyl methacrylate repeat units.

11. The article of claim 8, wherein the film further comprises a second polymeric layer adjacent and substantially coextensive with the particle layer, said second layer being translucent.

12. The article of claim 11, wherein the particle layer lies between the second layer and the surface of the substrate.

13. The article of claim 11, wherein the film is a coextruded film.

14. The article of claim 11, wherein the second polymeric layer comprises a (meth)acrylic ester polymer or copolymer.

15. The article of claim 8, wherein the substrate comprises a thermoplastic polymer.

16. The article of claim 15, wherein the thermoplastic polymer comprises a (meth)acrylic ester polymer or copolymer.

17. The article of claim 8, further comprising a light source fixed in proximity to the surface such that light from the light source may pass through the film.

18. A method of forming an article, the method comprising:
a) placing in a mold a translucent film comprising a particle layer having a thickness in the range of 5 mil to 20 mil, the particle layer comprising a polymer matrix having dispersed therein an effective amount of light-diffusing particles; and
b) introducing into the mold a liquid polymer precursor or a melted thermoplastic polymer;
wherein the liquid polymer precursor or melted thermoplastic polymer forms a translucent solid substrate bearing the film on a surface thereof.

19. The method of claim 18, wherein the polymer matrix comprises a (meth)acrylic ester polymer or copolymer.

20. The method of claim 18, wherein step b) comprises introducing a melted thermoplastic polymer, said polymer being a (meth)acrylic ester polymer or copolymer.

21. The method of claim 18, wherein the film further comprises a second polymeric layer adjacent and substantially coextensive with the particle layer, said second layer being translucent.

22. The method of claim 21, wherein the second polymeric layer comprises a (meth)acrylic ester polymer or copolymer.

23. The method of claim 21, wherein the second polymeric layer has a thickness in the range of 5 mil to 50 mil.

24. The method of claim 21, wherein the step of placing the film in the mold comprises placing the second polymeric layer against an internal surface of the mold, whereby the introduced melted thermoplastic polymer or liquid polymer precursor contacts the particle layer, and whereby the article bears the second polymeric layer on a surface thereof.
